(19) United States
(12) Patent Application Publication
(10) Pub. No.: US 2013/0138752 A1
(43) Pub. Date: May 30, 2013

(54) RELATIONSHIP-MANAGED COMMUNICATION CHANNELS

(71) Applicants: Paul D. Guthrie, San Francisco, CA (US); Andrew L. Dale, Berkeley, CA (US); Michael Tolson, Corte Madera, CA (US); Christopher L. Buchanan, Foster City, CA (US)

(72) Inventors: Paul D. Guthrie, San Francisco, CA (US); Andrew L. Dale, Berkeley, CA (US); Michael Tolson, Corte Madera, CA (US); Christopher L. Buchanan, Foster City, CA (US)

(21) Appl. No.: 13/747,345

(22) Filed: Jan. 22, 2013

Related U.S. Application Data
(62) Division of application No. 10/944,440, filed on Sep. 17, 2004, now abandoned.
(60) Provisional application No. 60/610,098, filed on Sep. 14, 2004.
(60) Provisional application No. 60/610,008, filed on Sep. 14, 2004.

(51) Int. Cl. H04L 12/58

(52) U.S. Cl. CPC H04L 51/12
USPC 709/206

(57) ABSTRACT

Systems and methods for managing computer-assisted communications channels based on relationships between users who wish to communicate with one another are described. The relationship-managed communications system allows users to retain control over whom they permit to communicate with them and under what conditions such communications may take place, for example when they take place and/or using which communications channels, by allowing pairs of users to establish relationships which specify communications permissions. Users of the system provide their contact information to the relationship-managed communications system, and the system uses the securely stored information to mediate the establishment of communications channels between users. Embodiments of the system may intelligently route communications to substitute channels based on relationship-related and other information. Systems and methods are further provided for selectively publishing information about users and for providing event notification services in association with the establishment of relationships.

### PRIORITY CLAIMS AND RELATED APPLICATION

The present application claims priority benefit under 35 U.S.C. 119(e) from U.S. Provisional Application No. ______, filed Sep. 14, 2004 with Attorney Docket No. CJB.002PR and entitled RELATIONSHIP-MANAGED COMMUNICATIONS CHANNELS, and from U.S. Provisional Application No. ______, filed Sep. 14, 2004 with Attorney Docket No. CJB.003PR, entitled DISTRIBUTED SECURE REPOSITORY, both of which are hereby incorporated herein by reference in their entireties. Furthermore, the present application is related to the co-pending and commonly owned U.S. Patent Application No. ______ entitled DISTRIBUTED SECURE REPOSITORY, filed on even date herewith with Attorney Docket No. CJB.003A and incorporated herein by reference in its entirety.

### FIELD OF THE INVENTION

The invention relates to the field of computer networks and, more particularly, to systems and methods for managing communications between network users.

### BACKGROUND OF THE INVENTION

Computer-assisted communications, in a variety of formats, such as e-mail, instant messaging (IM), voice-over-internet-protocol (VOW), short message service (SMS) for cellular phone text messaging, multimedia, and other forms of file transfer and digital data stream technologies, are becoming increasing popular and more widely available to users who want to communicate with one another. Using the Internet or other wired or wireless network systems, users may initiate and/or accept communications in a variety of locations with the help of a variety of communications devices, and at virtually any time of the day or night, at costs that are a fraction of what they may have been just a decade ago, if options for such communications were available at all. Furthermore, users who wish to transmit a communication to a large number of others may now do so with greatly enhanced ease and speed and at greatly reduced cost.

However, together with the advantages made available by computer-assisted communications have come an array of attendant disadvantages. For example, many users receive an overload of unwanted communications and struggle to maintain control over their privacy, their private identification information, and their communications generally.

Unsolicited e-mail (“spam”) continues to elude filter programs and proliferates. Users cannot easily prioritize or route phone messages based on the person calling. Additionally, users generally must give out contact information to receive communications. Users generally cannot maintain control over how their contact information is used or distributed or keep it up to date in other users' address books.

Furthermore, currently available systems for controlling communications frequently provide only imprecise control mechanisms that may, for example, block all communications from an identified individual or forward all calls from one phone number to another. Refusing to share contact information protects privacy only at the expense of foregoing communication.

In the light of the foregoing, conventional communications channels provide users with inadequate control of their communications.

### SUMMARY OF THE INVENTION

Embodiments of the system and method described herein allow users to control their communications by providing a system of communications channels that are managed based on relationships established and expressed between parties wishing to communicate with one another. A relationship manager allows two users of the system to establish a relationship, wherein establishing the relationship comprises allowing each user to designate a set of permissions that define conditions under which the user is willing to accept communications from the other user. The relationship-related conditions may include, for example, a definition of permissible and impermissible time periods for communication, as well as limitations on the types of communications (text messages, voice-mails, IMs, and the like) that the user is willing to accept from the other user. In various embodiments, other conditions, long- and short-term, may be set for permissible communications. Each party in a relationship may set different permission conditions for the relationship, as will be illustrated with reference to FIGS. 4 and 5, and may change those permissions settings independently of one another.

In various embodiments, the system provides additional flexibility to the setting of permissions by allowing for temporary overrides of the normal permission instructions. In various embodiments, the system additionally or alternatively allows users to specify permissions instructions that are based at least in part on priority levels of tasks with which the user is involved and in association with which the user expects to receive communications.

Users of the relationship-managed communications system retain control over their own contact information, and may share portions of it with only the relationship-managed communications system. A user may direct the system to securely maintain the privacy of the user's contact information, making use of the contact information to establish communications channels with the user on behalf of others only as prescribed by the user's relationship-related permissions. The system may mediate communications with the user without providing to others the contact information that would allow the others to establish communications with the user on their own. Thus, a first user may modify communications permissions that control a second user's ability to communicate with the first user using a given communications channel, and the system will reflect the modified permissions in managing any subsequent communications requests on the part of the second user.

In various embodiments, allowing users to maintain control of their own contact information additionally allows the users to modify their system-stored contact information for updates, such as when an IP address is updated, without need to individually notify and update the information with all users who may now or in the future wish to communicate with the first user. Other portions of the user's contact and other personal information stored by the system may be shared with other users based on permissions that are set and stored with respect to the associated relationship.

Embodiments of the relationship-managed communications system may further provide services to users that include, for example, intelligently routing communications to substitute channels based on relationship-related information, securely storing logs of all communications, securely storing copies of file-based communications, making information about users available to other users as specified in the relationship-related parameters, and providing relationship-related event notification services to users. These and other features of the systems and methods described herein are more particularly pointed out with reference to the figures in the detailed description to follow.

An embodiment of a method for managing computer-based communications between a first user and a second user is described. The method comprises the act of establishing a relationship between a first user and a second user, wherein the relationship defines a set of communications channels that the first user is allowed to use to communicate with the second user. The method further comprises the acts of: storing information about the relationship; receiving a request from the first user to open a communications channel to the second user; accessing the stored relationship information to determine if the requested communications channel is among the set of allowed communications channels; and opening the communications channel if the requested communications channel is among the set of allowed communications channels.

An embodiment of a computer-based system for managing communications between users is described. The system comprises: a communications permissions repository for storing information about communications channels that a first user is allowed to use to communicate with a second user and a messaging module configured to receive from the first user a request to communicate with the second user using a communications channel. The messaging module is further configured to access the communications permissions repository to determine if the first user is allowed to use the communications channel. If the first user is allowed to use the communications channel, the messaging module is further configured to accept a computer-based communication for the second user from the first user.

An embodiment of a computer-based system for managing communications between users is described. The system comprises a configuration module and a messaging module in communication with the configuration module. The configuration module is configured to establish a relationship between a first user and a second user and to allow the first user to specify parameters for acceptable communications that the first user is willing to receive from the second user. The configuration module is further configured to allow the second user to specify parameters for acceptable communications that the second user is willing to receive from the first user and to store in a permissions repository information about the parameters specified by the first user and the parameters specified by the second user. The messaging module is configured to receive from the first user a computer-based communication for the second user and to access the permissions repository to determine if the computer-based communication conforms to the second user's specified parameters. If the communication conforms to the second user's specified parameters, the messaging module is further configured to notify the second user about the computer-based communication.

An embodiment of a method for establishing a relationship between a first user and a second user of a relationship-managed communications system is described. The method comprises the acts of: receiving a request from a first user to establish a relationship with a second user; receiving relationship-related data from the first user defining communications permissions that the first user allows to the second user; allowing the second user to provide relationship-related data defining communications permissions that the second user allows to the first user; and storing the relationship-related data from the first user and the relationship-related data from the second user.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram depicting one embodiment of a relationship-managed communications system.

FIG. 2 depicts some features of a relationship between two users in an embodiment of a relationship-managed communications system.

FIGS. 3A and 3B depict two alternate methods for identifying users with whom to establish relationships in an embodiment of a relationship-managed communications system.

FIG. 4 depicts a simplified user interface of a first user's relationship manager, detailing the first user's relationship with a second user.

FIG. 5 depicts a simplified user interface of the second user's relationship manager, detailing the second user's relationship with the first user.

FIG. 6 depicts a simplified user interface of a user interface presented by the second user's relationship, detailing the second user's relationship with a computer process.

FIG. 7 depicts a simplified version of a user's event matrix.

FIG. 8 depicts a simplified version of a user interface that allows a user to designate default relationship permissions for newly formed relationships.

FIG. 9 depicts one embodiment of a simplified user interface in which a user may enter personal identification information along with permissions regarding which users may have access to individual portions of the information.

FIG. 10 depicts another version of the permissions information from FIG. 9.

FIG. 11 is a flowchart that depicts one embodiment of a process for establishing a relationship.

FIG. 12 is a flowchart depicting one embodiment of a process for initiating a communications channel based on the relationship established between two users.

### DETAILED DESCRIPTION OF THE PREFERRED EMBODIMENT

Systems and methods described herein are implemented by a relationship-managed communications system that securely stores contact information for users and that routes communications between users based on permissions-related information received from users regarding communications that they are willing to accept.

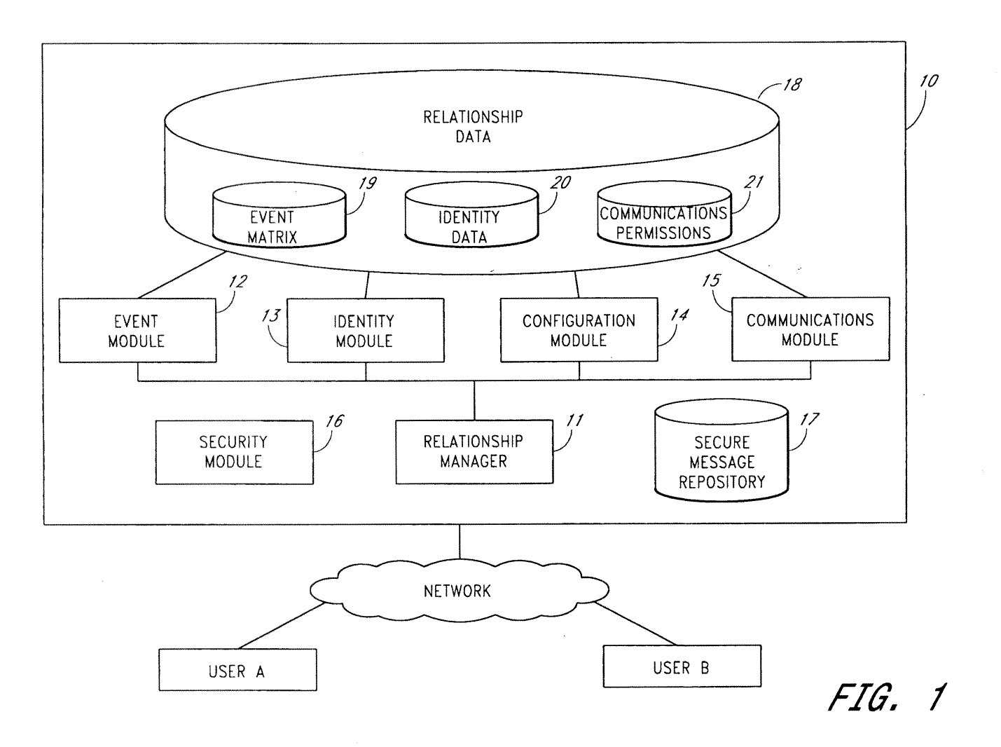

FIG. 1 is a block diagram depicting one embodiment of a relationship-managed communications system 10 that manages computer-assisted communications between a first user, identified here as User A, and a second user, identified in the figure as User B. The system 10 may be implemented using a client-server architecture on a computer server that communicates with users via the Internet or other wired or wireless communications network. Although the relationship-managed communications system 10 is depicted in FIG. 1 as a centralized entity operating on one or more computer servers, in various other embodiments, the system 10 is advantageously implemented on a plurality of distributed servers, such as a set of federated and mutually-trusted servers working in concert. Well-known cryptographic methods may be employed to ensure the security of data shared amongst the servers, such as, for example, an assertion by one server that an identified individual is a credentialed user of the system. In such distributed embodiments, individual components 11-21 of the system 10, as will be described in greater detail below, may be implemented on some, all, or none of the plurality of distributed servers in order to carry out functions of the system 10. Furthermore, in various embodiments, a portion of the functions carried out by the system components 11-21 described herein, may be carried out by computer servers, personal computers (PCs), mobile devices, or embedded or other types of processors associated with the users of the system 10.

In various embodiments, the system 10 controls access to identifying contact information for users that initiate communications on some types of communications channels and does not control access to identifying contact information for users that initiate communications on other types of communications channels. In general, the system 10 retains greater control over communications that are established using channels whose protocols do not inherently includes users' identifying contact information in the protocol. Such controllable communication channels include IM, telephone, VOIP, secure text messaging systems, and other channels described herein. For these channels, the communications system 10 preferably retains control over the contact information used for the communication rather than making it available to the receiver of the communication. Furthermore, for communications conducted over these channels, the system 10 retains control over access to the content of the communication and may, for example, impose limitations on a receiver's ability to ford, copy, or store a received message.

Other types of communications channels, such as conventional e-mail systems, inherently carry identifying information in their protocols. Some embodiments of the system 10 provide users with an option for communicating using e-mail or similar systems in an “uncontrolled” manner, namely, in a manner that does not hide a sender's contact information and does not allow the sender to retain control over the e-mail message itself. Other embodiments of the system 10 may alternatively provide controlled access to e-mail channels by adding extra layer(s) of security to conventional email systems. For example, as will be familiar to practitioners of ordinary skill in the art, e-mail systems can be modified such that the sender of the message is not readily identifiable. Legal requirements and regulations in some jurisdictions may prohibit systems that allow senders of e-mail to remain anonymous. Thus, in anticipation of such legal requirements, while technically feasible, a preferred embodiment does not include features that maintain the anonymity of e-mail senders' identities. An alternative to e-mail used by embodiments of the system 10 is secure messaging, as described herein.

Users of the system 10 may be individual persons who have contracted with the system 10 to have the system route communications coming to them from other users and going out from them to other users, based on relationship-based information provided by the users. In various embodiments, users of the system 10 may also be other types of entities. For example, a corporate or other commercial entity, such as a website order processor, may be registered with the system 10 as a user and may communicate with other users as a single entity. Similarly, a grouping of individuals communicating as a single entity may be a user of the system 10. In some embodiments, more abstract users, such as a computer process with whom other users may want to communicate may be registered as a user of the system 10. For ease of description, in this application, the pronoun “he” will generally be used to refer to a user of the system, referring equally to users who are male, female, groupings, or other types of entities, including logical components such as software systems, services, or agents.

As depicted in the embodiment shown in FIG. 1, the relationship-managed communications system 10 comprises a relationship manager component 11 that is in communication with various modules 12-16 of the relationship-managed communications system 10 for carrying out functions of the system.

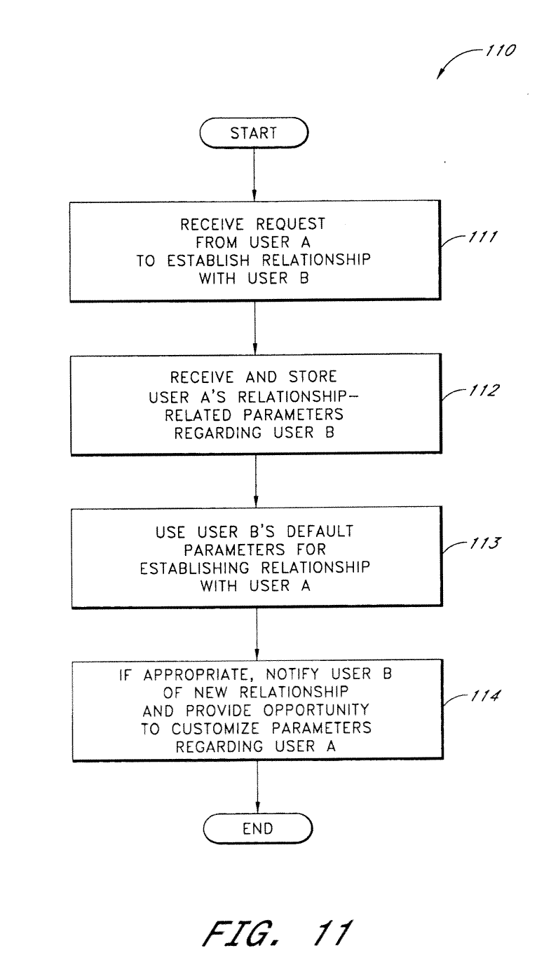

For example, the relationship manager 11 preferably instructs a configuration module 14 to establish a new relationship or to update permissions or other parameters associated with an existing relationship. FIG. 11 describes in greater detail one embodiment of a process for establishing a relationship between users. As part of the process for establishing a relationship between users, the configuration module 14 preferably obtains information associated with the relationship and may securely store the obtained information in a repository of relationship data 18.

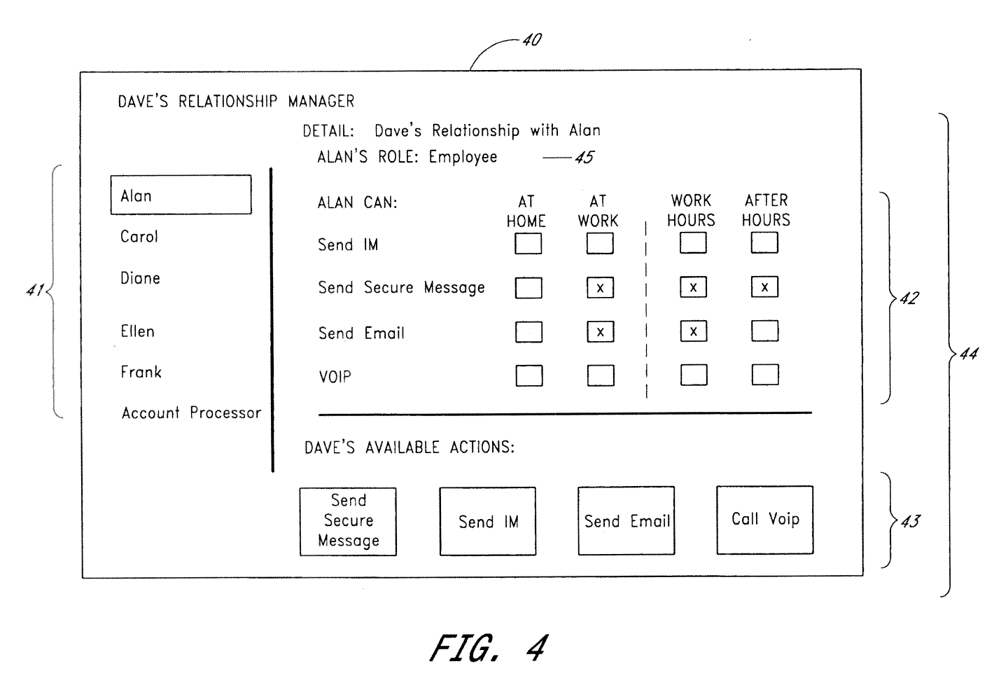

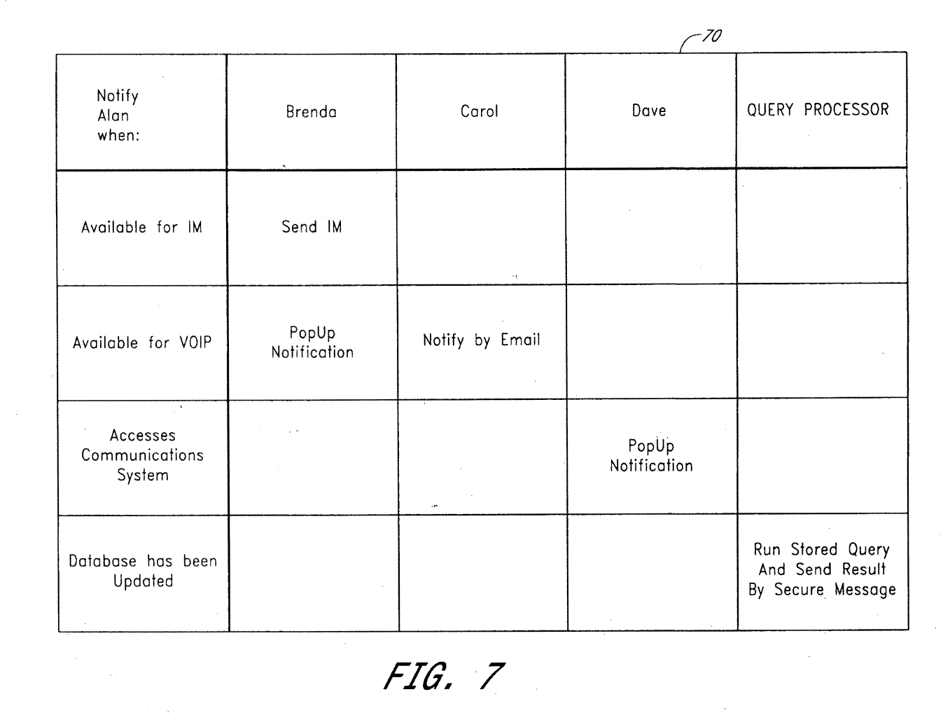

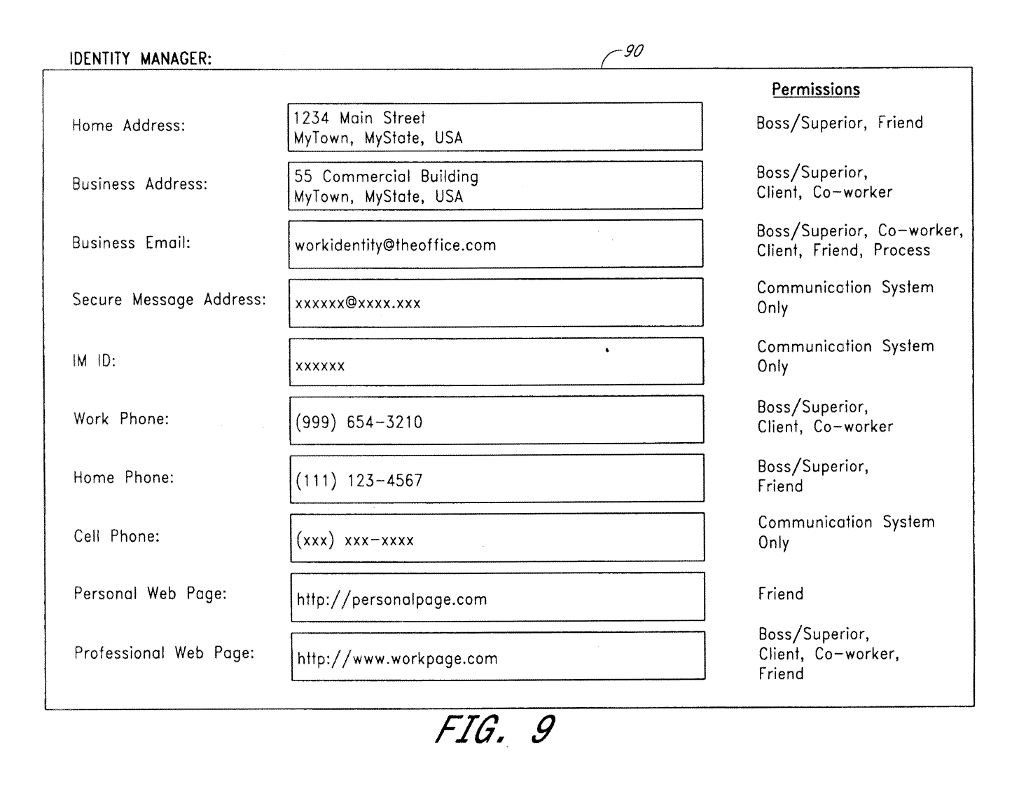

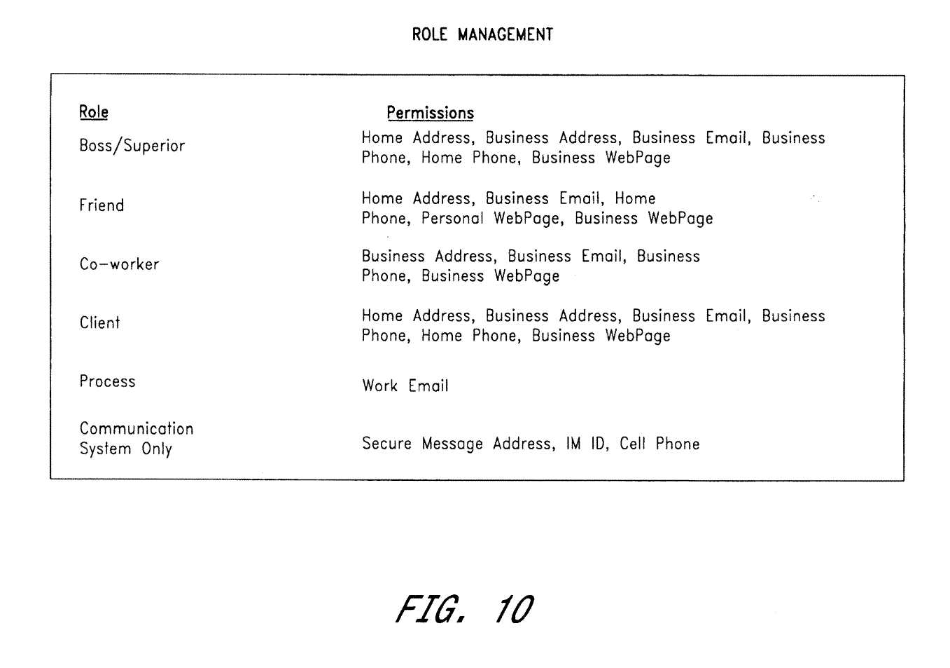

The relationship data 18 stored for an individual user preferably comprises a repository of the user's identity data 20, as will be described in greater detail with reference to FIGS. 9 and 10. The relationship data 18 stored for an individual user may also comprise a repository of communications permissions 21 that the user has designated with respect to his communications from another user, as will be described in greater detail with reference to FIGS. 4-6. In some embodiments, the relationship data 18 stored for an individual user may further comprise an event matrix 19 that defines relationship-related events about which the user has requested notification, as will be described in greater detail with reference to FIG. 7. Additionally or alternatively, the repository of relationship data 18 may comprise other types of data useful for managing communications and other interactions between users who have entered into relationships with one another.

In general, User A retains control over the contents of his identity data 20, his event matrix 19, and over the communications permissions 21 that he has set for communications coming to him from other users. Similarly, other users with whom User A may wish to communicate control permissions and conditions upon communications that they are willing to accept from User A, as well as controlling access that User A may have to their contact and other identity information 20. In various embodiments, the configuration module 14 allows individual users to modify and update their relationship data 18 as desired.

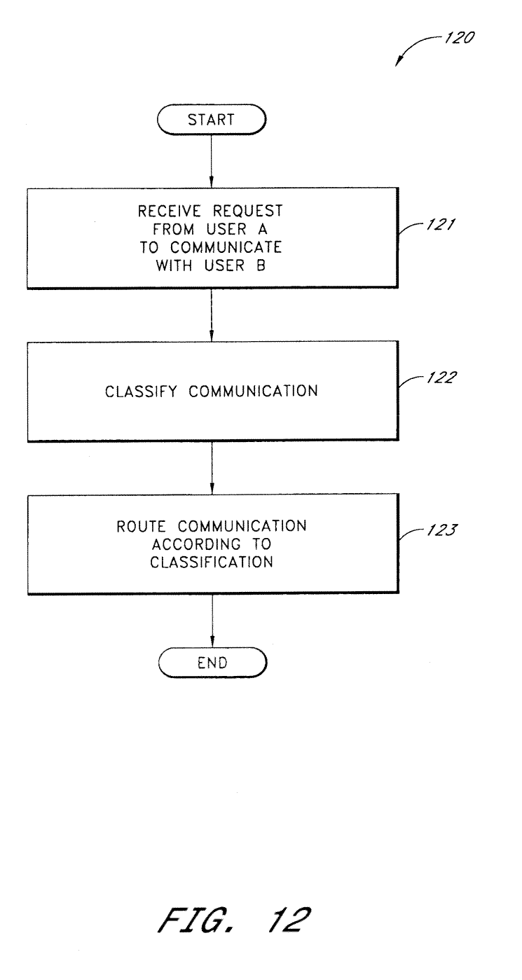

Once a relationship between two users is established and the communications permissions 21 of the users are designated, the relationship manager 11, upon request, preferably instructs a communications module 15 to establish a communications channel between the two users, based at least in part on the stored communications permissions 21. FIG. 12 describes in greater detail one embodiment of a process for establishing a relationship-managed communications channel between users. In some embodiments, the relationship-managed communications module 15 may securely store in a secure message repository 17 a copy, possibly in an encrypted form, of messages that are transmitted using the relationship-managed communications channels. In one embodiment, the relationship-managed communications module 15, storage, transmission, and management of security issues associated with the communication is handled by a distributed secure repository system as disclosed in U.S. Provisional Application No. ______, filed Sep. 14, 2004 with Attorney Docket No. CJB.003PR, entitled DISTRIBUTED SECURE REPOSITORY and in U.S. Patent Application No. ______ entitled DISTRIBUTED SECURE REPOSITORY, filed on even date herewith with Attorney Docket No. CJB.003A, both of which are incorporated herein by reference in their entireties.

The relationship manager 11 preferably instructs an identity module 13 of the system 10 to manage publication of a user's personal information based on relationship-related permissions provided by the user. In various embodiments, the relationship manager 11 instructs an event module 12 to carry out requested event notifications.

A security module 16 of the relationship-managed communications system 10 oversees security for the communications system 10. In various embodiments, the security module 16 enforces sign-on, credential, or other authentication procedures to allow users access to the system 10. The security module 16 may also oversee the security of contact information, identity information, messages and other data stored for users by the system 10 using encryption and other security methods. The security module 16 may also oversee the security of transmissions and communications with remote entities in association with the relationship-based communication managed by the system 10.

As stated above, FIG. 1 depicts one embodiment of a relationship-managed communications system 10 in which components 11-21 have been described in a given configuration so as to provide a broad overview of the system 10 and its functions. In other embodiments, the functions described herein, as well as other functions, may be carried out by a different configuration of the components or by a different set of components without departing from the spirit of the invention.

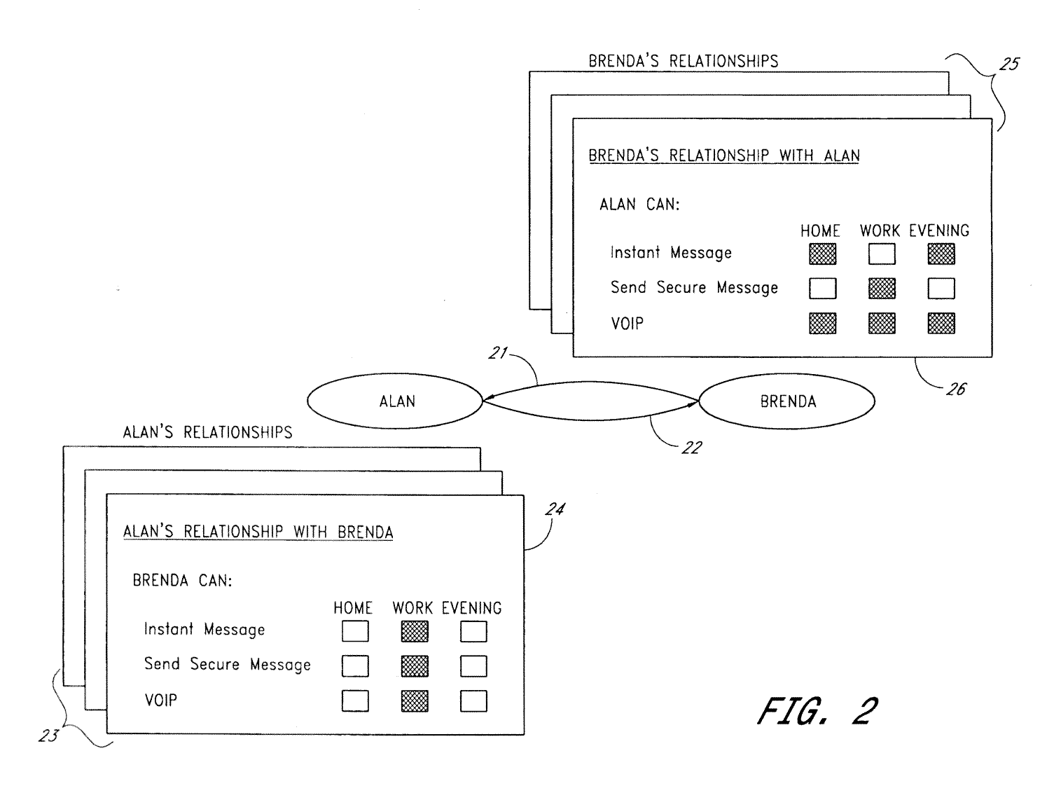

FIG. 2 depicts some features of a relationship between two users, here identified as Alan and Brenda, established by an embodiment of a relationship-managed communications system 10. A first user may choose to establish a relationship with a second user with whom the first user is acquainted or familiar. The first user identifies the second user and attempts to establish a relationship, as will be described in greater detail with reference to FIG. 11.

As depicted at the center of FIG. 2, the relationship between Alan and Brenda, for purposes of the system 10, may be broken down into Brenda's communications with Alan 21, which are controlled by Alan, and Alan's communications with Brenda 22, which are controlled by Brenda. Alan controls communications that he receives from Brenda and other users with permissions 23 that Alan has set for his established relationships. In particular, the simplified set of permissions 24 depicted for Alan's relationship with Brenda indicate that Alan allows Brenda to use any of the available communications methods, namely instant messaging, secure messaging, and VOIP, but only at work and only during the day. A skilled artisan will appreciate in light of this disclosure that FIG. 2 provides an example only and does not provide an exhaustive list of permissions parameters.

At the same time, Brenda controls communications that she receives from Alan and other users with permissions 25 that Brenda has set for her established relationships. In particular, the simplified set of permissions 26 depicted for Brenda's relationship with Alan indicate that Brenda allows Alan to IM her only at home in the evening, to send her a secure message only at work during the day, or to use VOW to communicate with her at work or at home during any time of day or evening.

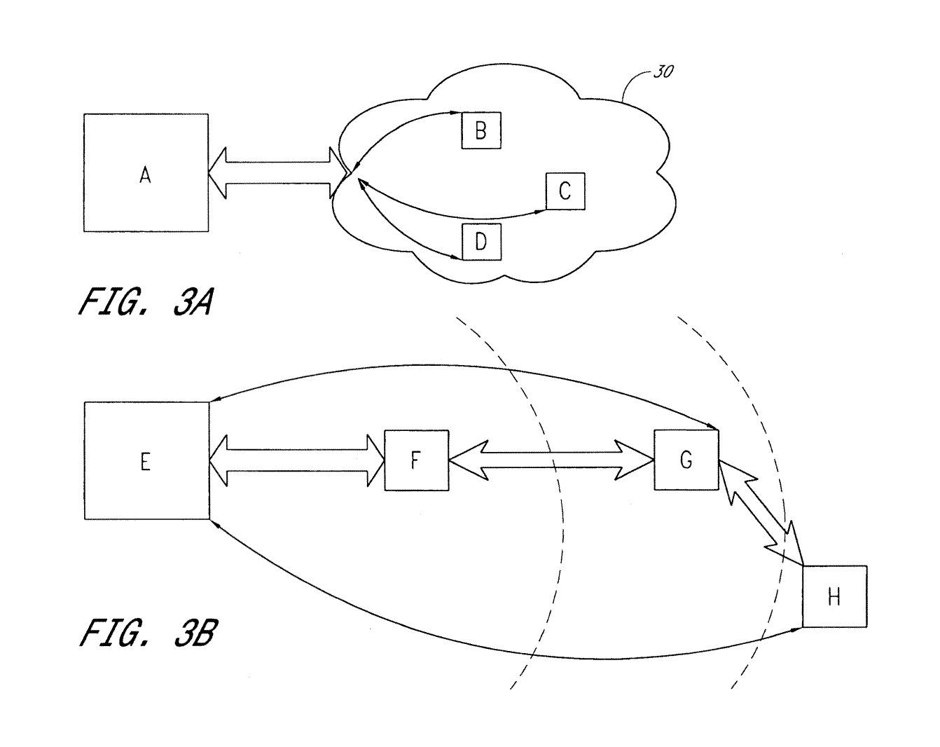

FIGS. 3A and 3B depict two alternate methods for identifying users with whom to establish relationships in an embodiment of a relationship-managed communications system 10. As depicted in FIG. 3A, User A may be aware of a defined community 30 of users who are associated in a way that is recognized by the system 10. For example, Users B, C, and D may be co-workers of User A or may live in the same city or may be signed up with an affinity group or may share another association. In some embodiments, User A may identify the users in the grouping 30 without being acquainted with them individually and may use the system 10 to initiate the establishment of individual relationships with Users B, C, and D. As depicted by the double-sided arrows of FIG. 3A, the relationships thus formed share the reciprocal nature of the more traditionally initiated relationship between Alan and Brenda described with reference to FIG. 2.

As depicted in FIG. 3B, User E may have an established relationship with User F. In some embodiments of the relationship-managed communications system 10, users may share a list of names or other identifications for other users with whom they have established relationships. If made possible by the system 10, User E can choose to initiate a relationship with another user, in this case User G, with whom User F has an established relationship. Identifying a potential relationship in this manner is analogous to identifying a “friend of a friend” as a potential “friend” himself. To carry this type of “derived” relationship one step further, User E may identify User H as a “friend of a friend of a friend” and use the system 10 to initiate a relationship with User H. Once again, as depicted by the double-sided arrows between Users E and G, and between Users E and H, of FIG. 3B, the relationships thus formed share the reciprocal nature of the more traditionally initiated relationship between Alan and Brenda described with reference to FIG. 2. Various embodiments of the system 10 allow for different levels of such “derived” relationships, or may not provide for their establishment at all.

FIG. 4 depicts a simplified user interface 40 of a relationship manager for a first user, here identified as Dave, detailing Dave's relationship with a second user, identified as Alan. As depicted in a list 41 along the left side of the user interface 40, Dave has established six relationships that are managed by the relationship manager. Dave selects Alan's name from the list, and more detailed information about Dave's relationship with Alan is displayed on a relationship detail portion 44 of the user interface 40.

For example, in the simplified user interface 40 depicted in FIG. 4, the detailed information comprises a definition of Alan's role 45 with regard to Dave, which in this case identifies Alan, in addition to being an individual in his own right with an individual relationship with Dave, as being an employee of Dave. In some embodiments, users may additionally or alternatively identify people or other entities with whom the users have established relationships as falling into one or more of the following roles: employee, employer, co-worker, assistant, supervisor, friend, relative, client, and the like. These and other role definitions 45 are used by some embodiments of the communications system 10 for a variety of purposes, especially where a grouping of relationships share common features, such as permissions limitations, or where the role name may be used as a convenient shortcut for identifying a plurality of individually-established relationships.

In some embodiments, the system 10 provides a set of pre-defined roles that a user may apply to relationships. In some embodiments, the system 10 additionally or alternatively provides capabilities for users to custom-define roles as deemed useful to them. In still other embodiments, roles are not used.

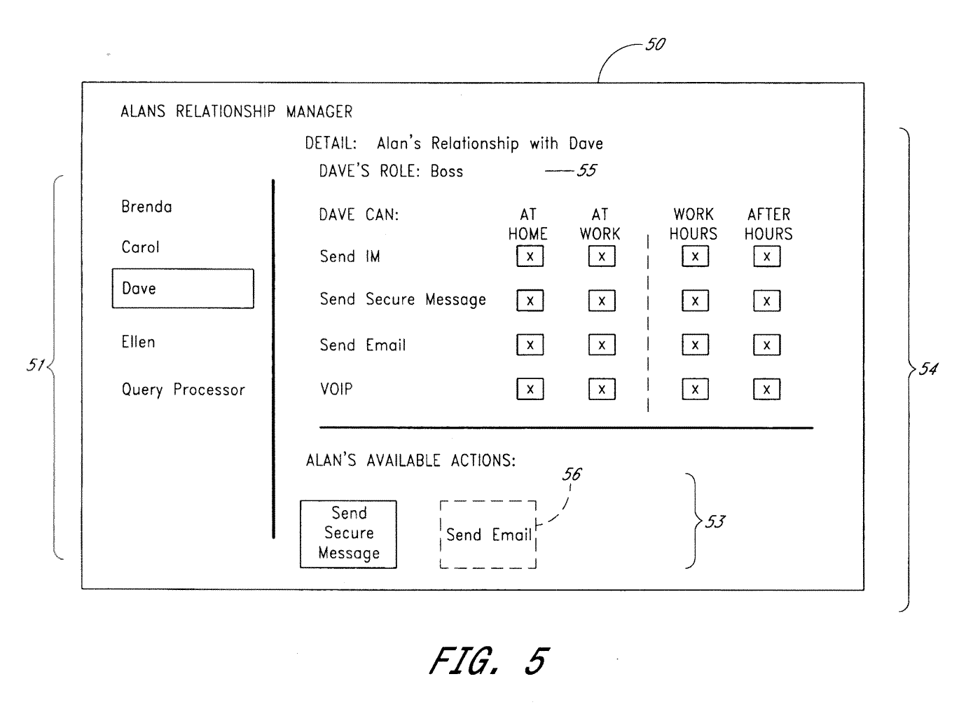

The user interface 40, as depicted in FIG. 4, further comprises a set of modifiable permission settings 42 that allow Dave to select communications channels and times that Dave permits Alan to use for communicating with Dave. For example, as depicted, Dave allows Alan to send him secure messages to his work location, both during work hours and after work hours. Alan is further permitted to e-mail Dave at work, but only during work hours. According to the permissions 42 as depicted, Dave does not permit Alan to send him an IM or make a VOIP call in any location or at any time. FIG. 5 depicts a user interface 50 with information about Alan's relationship with Dave, and shows how the communications restrictions that Dave has made regarding communications coming in to him are reflected in Alan's relationship manager user interface 50.

At the bottom of the sample user interface 40 of FIG. 4 are a set of buttons 43, icons or other selectors for allowing Dave to request that the computer initiate a permissible action, such as establishing a communications channel. The buttons 43 depicted in FIG. 4 indicate that Dave is permitted to communicate with Alan using the following methods; secure messaging, IM, e-mail, or VOIP. Selecting one of the buttons 43 instructs the computer to establish the indicated communication channel on behalf of Dave.

FIG. 5 depicts a simplified screenshot of Alan's relationship manager user interface 50, detailing Alan's relationship with Dave. A list 51 of Alan's five relationships is shown. Details 54 of Alan's relationship with Dave are depicted, indicating that Dave's role 55 with respect to Alan is that of a boss and that Alan permits Dave to contact him at any time using any available communications channel.

Buttons 53 depicted in FIG. 5 indicate that Alan is currently permitted to communicate with Dave using secure messaging. In the embodiment shown in FIG. 5, an inactivated but visible SEND EMAIL button 56 indicates that Alan is sometimes, but not currently, permitted to e-mail Dave. Buttons for communications channels with which Dave does not permit Alan to use to communicate with him at any time do not appear in Alan's set of available actions buttons 53. In other embodiments of the relationship-managed communications system, other systems for displaying/not displaying and activating/not activating the buttons 43, 53 may be implemented. For example, in some embodiments a button for every communication channel appears, even if the user cannot use the channels. This may be perceived as a method to protect privacy slightly more, as the receiver's permissions settings are not immediately apparent.

As indicated in the simplified example user interfaces depicted in FIGS. 4 and 5, a first user wishing to initiate a communication with a second user need not know the second user's contact information used for establishing the selected communications channel. Preferably, that contact information is stored securely in the repository of identity data 20 and not accessible to the first user. Preferably, the repository of identity data 20 stores the contact information in a table or other data structure that associates the secret contact information with the user's publicly-available user identification, such that the system 10 can readily determine the secret contact information. Preferably, however, the table or other data structure is encrypted such that no one but the user to whom the contact information pertains can access it. Encryption schemes capable of fulfilling this function are known in the art, and it will be appreciated that any such scheme that provides an adequate level of security can be used.

For example, in one embodiment, a first user may initiate a permitted VOIP communication with a second user by using a computer mouse to select a phone icon associated with initiating a VOIP session with the second user. Selecting the icon may successfully initiate the VOIP session. However, even after initiating the VOIP session, the first user does not possess the contact information used to establish the VOIP connection with the second user. Furthermore, the second user may revoke the first user's future ability to contact him at any time by changing the relationship-related permissions stored by the relationship manager. In the case of such revocation, the first user will no longer have access to use the contact information for establishing the communications channel.

If the second user wishes to revoke the first user's permissions to communicate using the channel, the second user need not worry about how the first user will use the now-unpermitted contact information, because the first user never had the contact information in question. The icon allowing the first user to contact the second user via the communication channel may be deleted or deactivated in the first user's relationship manager user interface 40, 50, and the second user is effectively denied access to the communications channel. In other embodiments, the VOIP icon is still visible to the second user, but any attempt to open a channel will be denied.

The second user may also update or otherwise modify his contact information, such as might occur if the second user changed interne service provider, causing future communications brokered by the relationship-managed communications system to be routed using the updated information. Preferably, the modification takes place transparently to other users communicating with the second user because the icons in their relationship manager user interfaces remain the same. In one embodiment, the modification is made once to contact information stored in a central identity data 20 repository such that there is no need to update the second user's contact information individually for each other user. Alternatively, the contact information can be distributed, in which case more than one update may be required.

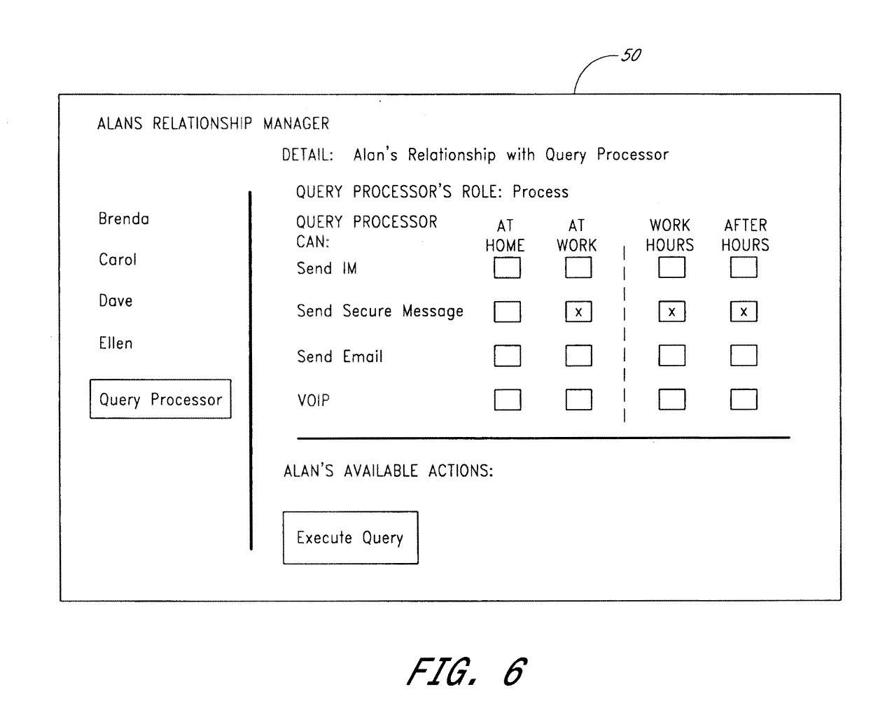

FIG. 6 depicts a simplified screen shot of Alan's relationship manager user interface 50, this time detailing Alan's relationship with an entity that is not another person, but is instead a computer process, namely a query processor of a database with which Alan interacts. FIG. 6 illustrates the fact that, in various embodiments, relationships may be established between entities and with entities that are not human individuals. Communications with such entities, for example with web services, with other types of computer processes or applications, with corporate or other commercial entities, or with groupings of human individuals acting as a single entity, may be managed by the relationship-managed communications system in much the same manner as a relationship between two individual humans. As depicted in FIG. 6, Alan permits the query processor to send Alan a secure message at work during any time, and Alan may communicate with the query processor by executing a query.

FIGS. 4, 5 and 6 depict basically a single simplified version of a user interface for a relationship manager 11. However, as will be clear to one of ordinary skill in the art, other embodiments of the relationship-managed communication system 10 may be implemented with user interfaces that exhibit a wide variety of configurations, layouts, selections of components, as well as services that they provide to the user, without departing from the spirit of the invention described and claimed herein.

Furthermore, in various embodiments of the system 10, in addition to the explicit time and/or communications-channel-related permissions that a user may specify for a relationship, the user may also be allowed to specify other types of permissions. For example, a user may be allowed to specify permissions that are in effect for a limited period of time, which may be pre-defined in length or may be defined to continue until notified by the user. A user interface may allow the user to click on a “Do Not Disturb” button that temporarily suspends permissions to communicate with the user for all or a subset of the user's relationships.

As another example of permissions that are implemented by some embodiments of the system 10, a user is permitted to assign priority levels to defined projects or tasks with which he is involved and in association with which he expects to receive communications. For example, assuming that the user is currently involved with four tasks, Tasks 1 and 4 being designated as high priority tasks, Task 2 being designated as a low priority task, and Task 3 being designated as a medium priority task, the user can instruct the system 10 to classify route incoming communication requests based at least in part on priority levels of the tasks with which the communication requests are associated. High priority communications may trigger immediate notification of the user. According to instructions received from the user, incoming high priority text messages may be listed at the top of an incoming message list and/or the user may be notified by cell phone or pager of newly received messages. Medium priority phone calls may be routed to voice-mail, with a pop-up appearing on the user's computer screen to notify him of the voice-mail. Low priority calls may be routed to voice mail with no extra notification.

In various embodiments, the system 10 identifies the priority level of communication requests based on identification of the sender attempting to communicate. For example, a sender may be associated with a task, and thus with an associated priority level and communication handling strategy. In some embodiments, other mechanisms, such as parsing of communications subject lines or setting of priority flags may identify a task with which a communication is associated, even if the sender is associated with more than one of the user's prioritized tasks. Skilled artisans will appreciate that other mechanisms may be employed to classify communications by priority level.

Other types of permissions parameters may be set based on the system's 10 awareness of external events. For example, the system 10 may be configured to receive global positioning system (GPS) information from a user's laptop computer, or other location-related information from the user's cellular phone, and may enforce relationship-related communications permissions that are based on this information. For example, the system 10 can allow a user to require a secure message to be accessed from a laptop computer only when the laptop computer is located on company premises. This condition can be useful to prevent an employee from showing sensitive messages to someone outside the company, such as on a business trip. Another use is that a user can set permission such that he will not receive communications when he is in Europe, which may mean that he is on vacation. The system 10 may be configured to receive notifications from other external or internal computer systems, such as information about stock market activity from a remote server or information from the user's own desktop computer calendaring application, and may enforce relationship-related communications permissions based on this information. For example, with regard to calendaring, the system 10 can be configured in one embodiment, to not allow cell phone calls during scheduled meetings with a supervisor.

Permissions that the user specifies for a limited time may be seen as overrides that are temporarily used in place of the user's normally specified permissions, which resume effectiveness when the override is not in effect.

FIG. 7 depicts a simplified version of a user's relationship-managed event matrix 70, which may be used, in some embodiments, to store requests that a user makes for notifications from the system 10 regarding activities associated with the user's relationships. For example, the event matrix 70 depicted for Alan in FIG. 7 lists five notifications that Alan has requested with respect to his relationships: Alan would like to be notified by IM when Brenda is available for an IM, and he would like to receive a pop-up notification when Brenda is available for a VOIP session. The event matrix 70 further indicates that Alan would like to be notified by e-mail when Carol is available for a VOIP session, and would like to receive a pop-up notification when Dave accesses the communication system 10. Finally, the event matrix 70 indicates that when the database is updated, Alan requests that a stored query be sent to the query processor and that the result of the query be sent to Alan by secure message.

.The last example request provides an indication that in addition to tracking actions taken by entities with whom a user has established a relationship, the event module 12 may also be configured to track other types of events. For example, in this case, when the database is updated, Alan has requested a response. In other examples, a user may request that when his company's monthly sales goal has been met, that a congratulatory message be sent to the members of the sales team, or that when the temperature in Detroit, Michigan drops to a certain low, that he is prompted to call and check on his grandmother, or that when the Dow Jones Industrial Average reaches a threshold value, that a pre-specified sale or purchase activity be initiated.

In various embodiments, the system's 10 capability to provide event notifications may be aided, as least in part, by a log that is kept of events mediated by the system 10. In various embodiments, the log may comprise a more extensive or a more sparse set of information. Embodiments of the system 10 that provide for relationship-based event notifications may make a trade-off and maintain a desired balance between their ability to provide desired services to users and their ability to safeguard the privacy of their users. It will be appreciated that some users may consider an event response matrix feature to be a privacy concern. Out of respect for this viewpoint, some embodiments of the system do not have such a feature, or allow the feature to be disabled.

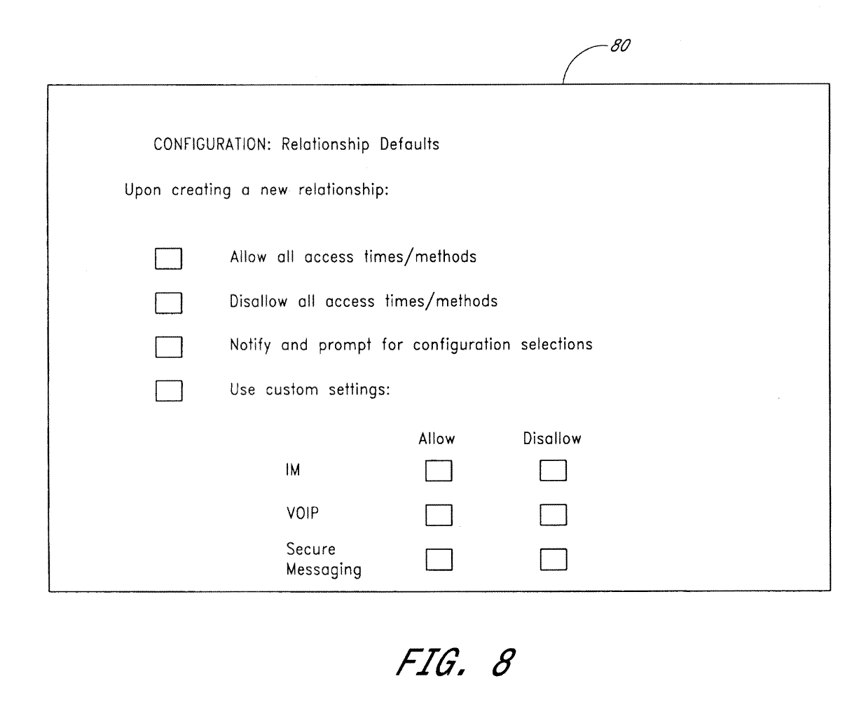

FIG. 8 depicts a simplified configuration user interface 80 that may be presented to a user by the configuration module 14, allowing the user to designate default communications permissions for future newly formed relationships. In various embodiments of the relationship-managed communications system 10, as will be described in greater detail with reference to FIG. 11, when a first user initiates establishment of a relationship with a second user, the first user is preferably provided with an opportunity to explicitly designate communication permissions that he grants to the second user. Preferably, the first user can initiate establishment of the relationship without the immediate knowledge of the second. If the second user has created and stored a set of default communications permissions for use with newly established relationships, such as those offered in the sample interface 80 of FIG. 8, then the system 10 applies the second user's default communications permissions to the new relationship with the first user. In some embodiments, the system 10 notifies the second user of the newly-created relationship with the first user, and provides an opportunity for the second user to customize the communications permissions as desired for the relationship with the first user. Whether default permissions are used to the user enters the permissions, the user preferably can change the permissions at any time.

In the sample user interface 80 depicted in FIG. 8, the user is provided with four basic options for default communications permissions. The user may initially allow all access times and channels to new relationships. The user may initially disallow any access times or channels to new relationships. The user may create a set of custom permissions that allows for explicit allowing or disallowing of individual types of communications channels. Thus, for example, the user may allow users in newly created relationships to communicate via IM only, or to have a different set of permissions. The user may also indicate that instead of providing default permissions, he wishes to be notified directly at the time of creation of a new relationship, so that he may at that time provide appropriate communications permissions. The user's designated default permissions may then be applied to newly created relationships.

In various other embodiments, the relationship-managed communications system 10 provides an opportunity for users to specify other types of default communications permissions. For example, in one embodiment, users who choose to specify custom settings for their permissions can also specify time periods associated with the permissions. As another example, in embodiments of the system 10 that make use of role-based user classifications, users may be provided an opportunity to specify default permissions that will be applied to newly created relationships based on roles associated with newly created relationships. In other embodiments, still other opportunities for defining default communications permissions may be provided to users.

FIG. 9 depicts one embodiment of a simplified role management user interface 90 in which a user enters personal identification information along with permissions regarding which users are allowed to access individual portions of the user's information. As depicted in the embodiment shown in FIG. 9, permission to view some of the information is granted based on roles that may be assigned to users as part of establishing a relationship. For example, in FIG. 9, permission to view the user's personal web page is granted only to user's who have been designated by role as being a “friend.” In other embodiments, permissions may be granted on an individual basis rather than on a role-based basis, or may be granted on a combination of the two, or on another basis, as will be familiar to one of ordinary skill in the art.

As further depicted in FIG. 9, some of the user's contact/identity information is available for use by the relationship-managed communications system 10, but not directly by individual users. For example, the user's secure message address, IM ID, and cell phone number are available only to the system 10, thus allowing the system to maintain control over communications coming in to the user via those channels.

FIG. 10 depicts another version of the permissions information from FIG. 9, again emphasizing that the user retains control over who may see his personal information and that some of the contact information, while available for use in initiating communications on behalf of other users, is not directly accessible to other users.

FIG. 11 is a flowchart that depicts one embodiment of a process 110 for establishing a relationship. As depicted in FIG. 11, the process 110 begins at a start state. In Block 111, a request is received from a first user, User A, to communicate with a second user, User B. In one embodiment, the request is received by the relationship-managed communications system 10.

In Block 112, User A's relationship-related communication permissions and other parameters associated with the proposed relationship with User B are received and stored. In one embodiment, the configuration module 114 of the system 10 receives and stores the communication permissions and other parameters.

In Block 113, User B's previously stored default communications permissions and other parameters are received and applied to the new relationship with User A. In one embodiment, the configuration module 14 locates and applies User B's default communications permissions and other parameters to the new relationship with User A. As described above with reference to FIG. 8, in some embodiments, rather than using User B's default permissions, User B is notified and asked to provide communications permissions for the new relationship with User A. Alternatively, in some embodiments, the system may apply a standard set of communications permissions to new relationships.

In Block 114, in some embodiments, User B is notified about the creation of the new relationship with User A and is optionally provided with an opportunity to modify his communications permissions and other parameters for the new relationship. In one embodiment, the relationship-managed communications system 10 notifies User B with the opportunity to modify his permissions and other parameters for the new relationship.

The process 110 comes to an end, and the new relationship is created, with permissions and contact information stored

FIG. 12 is a flowchart depicting one embodiment of a process 120 for initiating a communication based on a relationship established between two users. As depicted in FIG. 12, the process 120 begins at a start state. In Block 121, a request from User A to communicate with User B is received. In one embodiment, the communications module 15 of the relationship-managed communications system 10 receives the request from User A to communicate with User B.

In Block 122, the received communications request is classified. In one embodiment, the communications module 15 classifies the communication request based at least in part on relationship permissions and other parameters established for the relationship and stored in the repository of communications permissions 21. The communications module 15 determines whether the proposed communication from User A is currently permitted by the stored relationship permissions, based on the communications channel requested, current time of day and/or day of week, and/or any other conditions set forth in the stored communications permissions for the relationship. In other embodiments, these acts are carried out by other components of the system 10.

In some embodiments, the communication is also classified based at least in part on a variety of other factors. The communications module 15 may further determine whether temporary overrides of the standard permissions have been authorized by the intended recipient of the proposed communication. For example, the recipient may have submitted a permissions override to the system 10 indicating that although he commonly accepts communications from a variety of users during his lunch hour, he is currently in an important meeting and will accept communications only from his supervisor. Or, the recipient may have submitted a permissions override indicating that although he generally accepts communications from his stock broker only during work hours, now that an important corporate merger is being discussed, he will accept communications from his stock broker at any time of the day or night. Priority levels defined by the recipient in association with tasks and/or with specific other users may be used to classify incoming communications.

In some embodiments, users initiating a communication provide an indication of the importance or urgency of the communication that can be used to classify the communication. In some embodiments, users indicate a task or priority level associated with communications that they initiate.

In Block 123, communications that have been determined to be currently permitted are routed to appropriate communications channels. In one embodiment, the communications module 15 routes the currently permitted. The communications module 15 may route the communication using the communications channel requested by User A. In some embodiments, the communication may be routed using a substitute communications channel, according to the classification of Block 122 that took into account relationship parameters, temporary override rules, and/or importance levels declared by User A. For example, continuing to use the first example from Block 122, the communications module 15 may route requested telephone calls and VOIP sessions intended for the user who is in an important meeting, and from anyone other than the user's supervisor, to a voice-mail system for the user.

In some embodiments of the relationship-managed communications system 10, the system 10 may be configured to identify a communications device, such as an office computer workstation, a cell phone, or a wireless PDA, currently being used by a user. The system 10 may be further configured to identify a current location and/or activity of the user, based on the current device use and/or on other available location/activity-related information, and to route communications accordingly. For example, if the communications module 15 receives information indicating that the user in the second example from Block 122 is currently driving in his car, the communications module 15 may route requests for a VOIP session or call to the user's office from the user's stockbroker directly to the user's cell phone. Thus, the relationship-managed communications system 10 may provide decision-making capabilities for re-routing communications to alternate communications channels based on rule-based, neural network, decision-tree, probabilistic, genetically-programmed, or other type or combinations of types of learning and/or decision-making technologies.

Systems and methods for managing computer-based communications between users based on the establishment of relationships and the articulation of communications permissions based on the relationships have been described herein. Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A method for managing computer-assisted communications between users, such that users control who is permitted to communicate with them, what computer-assisted communication channels others are permitted to use for communicating with them, and when others are permitted to communicate with them, and users are further provided with options to specify additional instructions regarding the routing and management of communications that come to them, the method comprising:
establishing, at the request of a first user, a communication relationship between the first user and a second user, including receiving from the first user identifying information about at least one computer-assisted communication channel that the first user permits the second user to use for communicating with the first user, receiving from the first user information about time periods during which the first user limits the second user's permission to use the at least one identified communication channel, and receiving additional instructions that the first user gives the relationship-managed communications system for managing the second user's ability to communicate with the first user, such as instructing the communications system to re-route incoming communications from one channel to another channel under specifically defined conditions;
securely storing contact information that allows for accessing the at least one computer-assisted communication channel for communicating with the first user;
informing the second user about the communication relationship with the second user;
receiving a request from the second user to communicate with the first user using a first communication channel;
determining whether the second user is currently permitted to communicate with the first user using the first communication channel and determining whether any additional instructions from the first user apply to the communication; and
if the second user is currently permitted to communicate with the first user, initiating use of a communications channel with first user on behalf of the second user in accordance with the additional instructions from the first user, wherein the second user need not possess the contact information that allows for initiating use of the communication channel.

2. A relationship-managed communications system for managing computer-based communications between users, such that users of the system have control over who is permitted to communicate with them, when others are permitted to communicate with them, and using which communications channels others are permitted to use to communicate with them, the relationship-managed communications system comprising:
a configuration module configured to receive and store contact information in an identity repository, wherein the contact information provides access information for opening one or more computer-assisted communications channels to a first user, the configuration module further configured to receive and store relationship-related data in a communications permissions repository, wherein the relationship-related data comprises information received from the first user about other users who are permitted to contact the first user, and about communications channels that each of the other users is permitted to use to communicate with the first user, and about times when the each of the other users are permitted to use each of the communications channels; and
a communications module configured to receive from the second user a request to open a computer-assisted communications channel with the first user, the communications module further configured to determine, based on the relationship-related data from the first user with respect to the second user, whether the second user is permitted to communicate with the first user using the requested computer-assisted communications channel, and if the second user is permitted to communicate with the first user using the requested computer-assisted communications channel, opening the computer-assisted communication channel on behalf of the second user, wherein the second user need not possess the contact information used by the relationship-managed communications system to open the communication channel.

3. A method for managing computer-based communications between a first user and a second user, the method comprising the acts of:
establishing a relationship between a first user and a second user, wherein the relationship defines a set of communications channels that the first user is allowed to use to communicate with the second user;
storing information about the relationship;
receiving a request from the first user to open a communications channel to the second user;
accessing the stored relationship information to determine if the requested communications channel is among the set of allowed communications channels; and
opening the communications channel if the requested communications channel is among the set of allowed communications channels.

4. The method of claim 3, wherein establishing a relationship further comprises receiving from the second user information about one or more time periods associated with each communications channel in the set, wherein during the one or more time periods the first user is allowed to use the associated communications channel to communicate with the second user.

5. The method of claim 3, further comprising the act of:
opening a substitute communications channel if the requested communications channel is not among the set of allowed communications channels and if the information received from the second user comprises instructions to use the substitute communications channel.

6. The method of claim 3, further comprising the acts of:
receiving from the first user information about a set of communications channels that the second user is allowed to use to communicate with the first user;
storing the information from the first user with the information about the relationship;
receiving a request from the second user to open a communications channel to the first user;
accessing the stored relationship information to determine if the requested communications channel is among the set received from the first user; and
opening the communications channel if the requested communications channel is among the set received from the first user.

7. The method of claim 3, wherein the set of set of communications channels that the first user is allowed to use to communicate with the second user comprises at least one of: a channel for secure message communications, a channel for instant messaging OM) communications, a channel for telephone communications, and a channel for voice-over-internet-protocol (VOIP) communications.

8. The method of claim 3, wherein the set of set of communications channels that the first user is allowed to use to communicate with the second user comprises at least one of: a channel for e-mail communications, a channel for file-transfer communications, a channel for facsimile (fax) communications, and a channel for short message service (SMS) communications.

9. The method of claim 3, wherein the set of set of communications channels that the first user is allowed to use to communicate with the second user is empty.

10. The method of claim 3, wherein the set of set of communications channels that the first user is allowed to use to communicate with the second user comprises digital communications channels.

11. A computer-based system for managing communications between users, the system comprising:
a communications permissions repository for information about communications channels that a first user is allowed to use to communicate with a second user; and
a messaging module configured to receive from the first user a request to communicate with the second user using a communications channel, the messaging module further configured to access the communications permissions repository to determine if the first user is allowed to use the communications channel, and, if the first user is allowed to use the communications channel, the messaging module further configured to accept a computer-based communication for the second user from the first user.

12. The computer-based system of claim 11, wherein the messaging module is further configured to notify the second user about the computer-based communication.

13. The computer-based system of claim 11, wherein the information in the communications permissions repository about communications channels that the first user is allowed to use to communicate with the second user is based at least in part on information supplied by the second user.

14. The computer-based system of claim 11, wherein at least a portion of the information in the communications permissions repository is contact information pertaining to the second user that is not accessible by the first user.

15. The computer-based system of claim 11, wherein the communications permissions repository further comprises information about at least one of: time periods associated with allowed communications channels, priority levels associated with use of allowed communications channels, permission overrides associated with use of communications channels, and substitute communication channels to be used in association with communications between the first user and the second user.

16. The computer-based system of claim 11, further comprising:
a repository of identity data about the second user, wherein the identity data comprises instructions from the second user specifying portions of the identity data that the system is not permitted to make available to the first user.

17. The computer-based system of claim 16, wherein the instructions from the second user comprise permissions that are based at least in part on a role that the second user identifies for the first user.

18. The computer-based system of claim 11, further comprising:
an event matrix that stores information about one or more requests from the first user to receive notification when a defined event associated with the second user occurs; and
an event module configured to access information in the event matrix, the event module further configured to receive information when the defined event occurs and to send a notification to the first user.

19. A computer-based system for managing communications between users, the system comprising:
a configuration module, configured to establish a relationship between a first user and a second user, the configuration module further configured to allow the first user to specify parameters for acceptable communications that the first user is willing to receive from the second user, the configuration module further configured to allow the second user to specify parameters for acceptable communications that the second user is willing to receive from the first user, the configuration module further configured to store in a permissions repository information about the parameters specified by the first user and the parameters specified by the second user; and
a messaging module configured to receive from the first user a computer-based communication for the second user, the messaging module further configured to access the permissions repository to determine if the computer-based communication conforms to the second user's specified parameters, the messaging module further configured to notify the second user about the computer-based communication if the communication conforms to the second user's specified parameters.

20. A method for establishing a relationship between a first user and a second user of a relationship-managed communications system, the method comprising the acts of:
receiving a request from a first user to establish a relationship with a second user;
receiving relationship-related data from the first user defining communications permissions that the first user allows to the second user;
allowing the second user to provide relationship-related data defining communications permissions that the second user allows to the first user; and
storing the relationship-related data from the first user and the relationship-related data from the second user.

21. The method of claim 20, wherein the relationship-related data from the second user indicates that the second user does not allow the first user to communicate with the second user.

22. A computer-based system for managing communications between users, the system comprising:
a communications permissions repository for information about communications channels that a first user is allowed to use to communicate with a second user; and
a messaging module configured to receive from the first user a request to communicate with the second user using a communications channel, the messaging module further configured to access the communications permissions repository to determine if the first user is allowed to use the communications channel, and, if the first user is allowed to use the communications channel, the messaging module further configured to receive from the first user an encrypted computer-based communication for the second user and permissions that define access limitations which the first user sets for the second user's access to the communication;
a repository of encrypted communications for securely storing the encrypted communication;
a repository of sender metadata that stores information about the communication including the permissions received from the first user and a storage location in the encrypted communications repository where the communication is stored; and
a remote access manager for sending recipient metadata to the second user, wherein the recipient metadata notifies the second user about the securely stored communication that the first user is storing for the second user, the recipient metadata further providing contact information that allows the second user to request access to the securely stored communication.

23. A system for managing computer-based communications between a first user and a second user, the system comprising:
means for establishing a relationship between a first user and a second user that defines a set of communications channels that the first user is allowed to use to communicate with the second user;
means for storing information about the relationship;
means for receiving a request from the first user to open a communications channel to the second user;
means for accessing the stored relationship information to determine if the requested communications channel is among the set of allowed communications channels; and
means for opening the communications channel if the requested communications channel is among the set of allowed communications channels.
